(19) United States
(12) Patent Application Publication
(10) Pub. No.: US 2025/0267437 A1
(43) Pub. Date: Aug. 21, 2025

(54) HYBRID CODEC PRESENT DELAY SYNC FOR ASYMMETRIC SOUND BOXES

(71) Applicant: QUALCOMM Incorporated, San Diego, CA (US)

(72) Inventor: Nan ZHANG, Beijing (CN)

(21) Appl. No.: 18/866,481

(22) PCT Filed: Aug. 2, 2022
(86) PCT No.: PCT/CN2022/109625

§ 371 Date: Nov. 15, 2024

(51) Int. Cl. H04W 4/80; G06F 3/16

(52) U.S. Cl. CPC H04W 4/80; G06F 3/162

(57) ABSTRACT

Embodiments include methods performed by a host device for syncing Bluetooth Low Energy (BLE) audio, including determining a first codec decoding delay of a first connected audio output device coupled to the host device via a first BLE connection, determining a second codec decoding delay of a second connected audio output device communicatively coupled to the host device via a second BLE connection, determining a difference in decoding delays of the first codec and the second codec, determining a compensation delay as a time difference between the first encoding-decoding delay and the second encoding-decoding delay, configuring one of the first BLE connection or the second BLE connection to include the present compensation delay, and transmitting audio data to the first connected audio output device and the second connected audio output device via the first BLE connection and the second BLE connection.

### CROSS-REFERENCE TO RELATED APPLICATIONS

This application for Patent is a 371 of international Patent Application PCT/CN2022/109625, filed Aug. 2, 2022, which is hereby incorporated by referenced in its entirety and for all purposes.

### BACKGROUND

User equipment (UE) and consumer devices for communicating audio data via a Bluetooth (BT)/Bluetooth Low Energy (BLE) have become increasingly complex, implementing various communications protocols referred to as codecs (Coder/Decoder) to convey and stream audio data from one device to another. To output audio data, these various UE and consumer products may implement one of many types codecs that encode audio information for transmission and decode received audio information for use in generating an audio output. Many codecs were designed for specific, and often proprietary, applications, such as low-latency, high-resolution/high audio quality, high bit rate, lossy, or lossless applications, and are not compatible with each other. Further, different codecs may exhibit different degrees of latency (e.g., from decode processing delays). Despite this, there is a growing market for speakers and devices including wireless speakers that are sold individually (i.e., not linked or limited to particular audio devices) so that consumers can assemble sound systems with as many speakers of as many varieties in as desired.

### SUMMARY

Various aspects include methods performed by a processor of a computing device functioning as a host device for syncing Bluetooth Low Energy (BLE) audio transmitted to audio output devices equipped with different codecs. Various aspects may include determining a first codec decoding delay of a first connected audio output device communicatively coupled to the host device via a first BLE connection, determining a second codec decoding delay of a second connected audio output device communicatively coupled to the host device via a second BLE connection, determining a first encoding-decoding delay based on the first codec decoding delay and a first codec encoding delay of the host device for the first BLE connection, determining a second encoding-decoding delay based on the second codec decoding delay and a second codec encoding delay of the host device for the second BLE connection, determining a present compensation delay as a time difference between the first encoding-decoding delay and the second encoding-decoding delay, configuring one of the first BLE connection or the second BLE connection to include the present compensation delay, and transmitting audio data to the first connected audio output device and the second connected audio output device via the first BLE connection and the second BLE connection.

In some embodiments, the first BLE connection may include a first Connected Isochronous Stream (CIS) of a Connected Isochronous Group (CIG) and the second BLE connection may include a second CIS of the CIG. In some embodiments, configuring one of the first BLE connection or the second BLE connection to include the present compensation delay may include configuring one of the first BLE connection or the second BLE connection to include the present compensation delay in the Isochronous Adaptation Layer (ISOAL) of the host device. In some embodiments, the first BLE connection implements a first codec type and the second BLE connection implements a second codec type that is different from the first codec type.

In some embodiments, determining the first codec decoding delay of the first connected audio output device may include analyzing a first connection response message received from the first connected audio output device when establishing the first BLE connection, and determining the second codec decoding delay of the second connected audio output device may include analyzing a second connection response message received from the second connected audio output device when establishing the second BLE connection.

Some aspects may further include transmitting a first codec decoding delay request message to the first connected audio output device, receiving a first codec decoding delay response message from the first connected audio output device, transmitting a second codec decoding delay request message to the second connected audio output device, and receiving a second codec decoding delay response message from the second connected audio output device. In such aspects, determining the first codec decoding delay of the first connected audio output device may include analyzing the first codec decoding delay response message, and determining the second codec decoding delay of the second connected audio output device may include analyzing the second codec decoding delay response message.

Some aspects may further include determining whether the first codec decoding delay was received from the first connected audio output device, and determining whether the second codec decoding delay was received from the second connected audio output device. In such aspects, determining the first codec decoding delay of the first connected audio output device may include determining a first default codec decoding delay based on a first codec type of the first BLE connection in response to determining that the first codec decoding delay was not received from the first connected audio output device, and determining the second codec decoding delay of the second connected audio output device may include determining a second default codec decoding delay based on a second codec type of the second BLE connection in response to determining that the second codec decoding delay was not received from the second connected audio output device. Further aspects include a computing device having a processor configured to perform one or more operations of any of the methods summarized above. Further aspects include a computing device having means for performing functions of any of the methods summarized above. Further aspects include a non-transitory processor-readable storage medium having stored thereon processor-executable instructions configured to cause a processor of a computing device to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a system block diagram illustrating an example communication system suitable for implementing any of the various embodiments.

FIG. 2 is a component block diagram illustrating an example computing device 200 suitable for implementing any of the various embodiments.

FIG. 3 is a component block diagram illustrating a software architecture including a Bluetooth Low Energy (BLE) stack implemented by a host device for establishing and maintaining multiple BLE connections for implementing any of the various embodiments.

FIG. 4 is a component block diagram illustrating an example system configured to synchronize BLE audio according to some embodiments.

FIG. 5A is a block diagram illustrating an example end-to-end delay of a conventional three-dimensional (3D) spatial audio system including devices with different audio codes.

FIG. 5B is a block diagram illustrating an example end-to-end delay of an asymmetric hybrid 3D spatial audio system including devices with different audio codes according to some embodiments.

FIG. 6A is a process flow diagram of an example method that may be performed by a processor of a host device for syncing BLE audio in accordance with various embodiments.

FIGS. 6B and 6C are process flow diagrams of example operations that may be performed as part of the method illustrated in FIG. 6A as described for syncing BLE audio in accordance with some embodiments.

FIG. 7 is a component block diagram illustrating an example computing device suitable for use with the various embodiments.

FIG. 8 is a component block diagram illustrating an example server suitable for use with the various embodiments.

FIG. 9 is a component block diagram illustrating an example wireless communication device suitable for use with the various embodiments.

FIG. 10 illustrates an example wearable computing device in the form of a smart watch according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Different types of user equipment (UEs) and/or commercial computing devices capable of audio output and Bluetooth (BT) and/or Bluetooth Low Energy (BLE) may implement various codec types for communicating and outputting audio data to a variety of commercially available speakers, earphones, and other audio output devices. Often consumers purchase audio output devices made by original equipment manufacturers (OEM) that are different from the OEM that made their UE, and sometimes consumers buy audio output devices made by multiple different OEMs.

Such mixing and matching of audio output devices from different OEMs can result in issues in the rendered audio. This is because audio output devices may use only one audio codec and different OEMs may use different audio codecs in their audio output devices products. Typically a host device, such as a smartphone, will be capable of implementing multiple codec types and thus sending audio data to multiple different types of audio output devices as described in Bluetooth Core Specification v5.2. However, different types of codecs implemented in different types of audio output devices may exhibit different latency characteristics due to decode processing delays. As a result of variations in codec latency, even if the host UE device transmits audio data to all connected audio output devices to support synchronous three-dimensional (3D) spatial audio, the sound produced by each of the various types of audio output devices may be produced with slightly varying delays. Thus, while a host device may connect simultaneously to multiple devices that use different BLE codecs, the audio produced by a mixture of different OEM audio output devices may not be synchronized, which may impact the user experience.

Various embodiments include methods and processors of a computing device (e.g., host UE device) for syncing BLE audio among multiple audio output devices with different codec types so that the sound produced by the various audio output devices is synchronized despite differences in codec latency of different audio output devices. Various embodiments include a processor of a host device configured to synchronize audio output among various audio output devices connected via BLE by offsetting audio data transmitted to one or more audio output devices based on a slowest end-to-end codec delay time (i.e., encoding delay time plus decoding delay time) amongst all of the connected audio output devices. Various embodiments include the processor of a host device may determine a first codec decoding delay of a first connected audio output device communicatively coupled to the host device via a first BLE connection, determine a second codec decoding delay of a second connected audio output device communicatively coupled to the host device via a second BLE connection, determine a first encoding-decoding delay based on the first codec decoding delay and a first codec encoding delay of the host device for the first BLE connection, and determine a second encoding-decoding delay based on the second codec decoding delay and a second codec encoding delay of the host device for the second BLE connection. In some embodiments, the processor of the host device may determine a present compensation delay as a time difference between the first encoding-decoding delay and the second encoding-decoding delay, configure one of the first BLE connection or the second BLE connection to include the present compensation delay, and transmit audio data to the first connected audio output device and the second connected audio output device via the first BLE connection and the second BLE connection.

As used herein, the terms “host device” and “host source device” may be used interchangeably to refer to a computing device that transmits encoded (e.g., digital) audio data to an audio output device. Non-limiting examples of computing devices that may function as a host device include user equipment (UE) such as smartphones, consumer and commercial computing devices (e.g., laptop, desktop and personal computers), home appliance user interfaces, voice-activated assistance devices (e.g., Amazon Echo R; and Alexa® devices, Google Assistant, etc.), extended reality/augmented/mixed reality (XR, AR, MR) devices, smart televisions, smart boxes, multimedia displays, and smart wearable devices (e.g., smart watches). In some cases, a host device may also function as an audio output device that both provides audio data to other connected audio output devices and produces sound (or outputs analog audio signals to a connected speaker), such as to produce sound that is synchronized with the sound produced by other connected audio output devices.

As used herein, the terms “audio output device” and “connected audio output device” refer to a device communicatively coupled to a host device (e.g., a UE or other computing device) that includes a codec for decoding received encoded (i.e., digital) audio data and producing an audio output (sound). In some products, an audio output device may receive encoded audio data via a BT or BLE transceiver and output analog audio signals to an analog speaker that produces the audio output. The term “audio output device” used herein is intended to encompass devices that in other contexts (e.g., communication protocols and standards) may be referred to as a “sink device.” “endpoint device.” “audio endpoint device.” or “endpoint audio device.” Non-limiting examples of audio output devices that may receive BT or BLE audio data from UEs and other computing devices include wireless speakers, sound boxes, smart speakers, multimedia displays, personal hearing devices, and the like.

The term “codec” is used herein to refer to a computer program or firmware that encodes and/or decodes an audio data stream or data signal. A codec may include a coder function that encodes an audio signal for transmission or storage, possibly in encrypted form, and a decoder function that decodes received encoded audio data into a signal (e.g., an audio signal) for rendering on an audio output device (e.g., a speaker).

The term “codec type” may be used herein to refer to a type of codec that defines the process of how a codec encodes and decodes data. Examples of codec types may include but are not limited to subband codec (SBC), Advanced Audio Codec (AAC), aptX, aptX low latency (LL), aptX HD, aptX Lossless, aptX Adaptive, Enhanced aptX, aptX Live, aptX Voice, Low Latency Audio Codec (LLAC), LDAC, Low Latency High-Definition Audio Codec (LHDC), Low Complexity Communication Codec (LC3), LC3 Plus, and Ultra Audio Transmission (UAT).

The term “system-on-a-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices.

The term “system-in-a-package” (SIP) may be used herein to refer to a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single computing device. The proximity of the SoCs facilitates high speed communications and the sharing of memory and resources.

Three-dimensional (3D) spatial audio technologies create an immersive audio experience for a user that aims to replicate how a user perceives sound in the real world. Such technologies go beyond conventional “surround sound” systems and may allow a user to experience spatial audio from any direction, sometimes based on the relative position of the user with respect to the audio output devices within the system. A 3D spatial audio experience may be created by implementing multiple synchronized audio output devices, which may output audio signals based on audio data streamed from a single source, such as a host device. A user may place audio output devices in various locations, such as in different corners of a room and at different elevations. To enable users to design their own 3D spatial audio listening experience, wireless smart speakers are sold individually or in small numbers. Consumers can now buy as many wireless smart speakers as desired, and connect their host device (e.g., a smartphone) to the speakers using wireless communication links (e.g., BT or BLE links) so that the speakers can be placed anywhere. Then to create a synchronized 3D spatial audio experience, each of the audio output devices establishes a wireless communication link to the host device, which a user can configure to output certain channels (e.g., left, right, front, back, base, treble, and other channels) to particular speakers. To ensure sound is synchronized, the host device may also be informed about the distances between individual speakers and the location of the desired listening area so that host device can send audio data to each speaker so that the sound heard by the user from all speakers is synchronized. The use of multiple dispersed speakers coupled to a host device that is configured to provide synchronized immersive 3D spatial audio experience may be deployed in a variety of places, including homes and commercial properties such as shopping malls, theaters, and theme parks.

Wireless audio output devices that may be used in synchronized immersive 3D spatial audio systems are manufactured several different OEMs, with products designed for different purposes (i.e., high-res audio, lossless audio, low-latency audio, etc.) As noted before, different audio output devices may use different audio codecs to decode audio data received from a host device. For example, Amazon, XiaoMI, Apple, Huawei, OPPO, VIVO, SS, Baidu, and XiMaLaYa all produce wireless sound boxes as Internet-of-Things (IoT) products, which may use a different codec. Wireless audio output devices are often sold or provided as single units instead of pairs or multiples. To provide spatial audio, multiple audio output devices are required to be positioned within a same audio environment (i.e., same room, and/or within listening distance of a user).

As noted, the encoding and decoding times of different types of codecs vary. For example, a device implementing aptX-HD codec exhibits different encoding and decoding times (or latency) than a device implementing the LC3 codec. The audio codec decoding delay or latency among various codecs may range from 40 ms to 400 ms. Thus, attempting to create a 3D spatial audio experience using multiple connected audio output devices from different OEMs that use various codecs may result in unsynchronized audio output. Conventional solutions to this problem in 3D spatial audio deployments involve limiting the multiple audio output devices to a same brand, type, and/or model so that each audio output device within a 3D spatial audio system uses the same codec. However, this limits the user's or installer's flexibility in selecting audio output devices, and some users may not be aware of the problem when purchasing devices for their system.

Various embodiments provide for asymmetric hybrid-device 3D spatial audio solutions by align different audio gaps due to variance in codec encoding/decoding delays (or latency) to produce synchronized 3D spatial audio by different types of audio output devices. Various embodiments enable users to utilize multiple audio output devices with different BLE audio codecs to create a synchronized 3D spatial audio experience. In particular, various embodiments may utilize the framework of multiple Connected Isochronous Streams (CIS) of a Connected Isochronous Group (CIG) (See BLE Core Specification v5.2) to create synchronized 3D spatial audio with multiple audio output devices having different codecs. Such a system, which is referred to as an asymmetric hybrid 3D spatial audio system, may provide synchronized BLE audio using audio output devices with different codecs by offsetting, or introducing a delay to, CIS data packets of BLE connections (i.e., in a CIS channel per an audio output device) of audio output devices with faster encoding and/or decoding times to align their audio output with one or more audio output devices having the slowest encoding and/or decoding times within the asymmetric hybrid 3D spatial audio system.

For example, a host device, e.g., a UE, may identify current alive (i.e., connected) BLE audio output devices and their associated audio codec types (e.g., LDAC, ACC, aptX, etc.). The host device may send a query to each connected BLE audio output devices requesting the device's codec decoding delay. In some embodiments, if a BLE audio output devices does not provide a codec decoding delay value in response to this query, the host source device may use a codec-specific default decoding delay value. In some embodiments, the codec-specific default decoding delay value may be based on a make or model of the connected audio output device, such as obtained from a look up table stored in memory of the host device. The host device may then calibrate or otherwise configure each BLE channel's delay in the BLE Isochronous Adaptation Layer (ISOAL) of the BLE transceiver. This delay calibration procedure may take both audio codec encoding delay and audio codec decoding delay into consideration for purposes of introducing a delay into each channel. Then during audio streaming, the host source device may transmit each channel's audio data in separate CISes corresponding to each BLE audio output device, in which each CIS is part of the same CIG. Each BLE audio output devices will then produce sound that is synchronized with all of the audio streams as if there was no difference in codec latency among the various audio output devices.

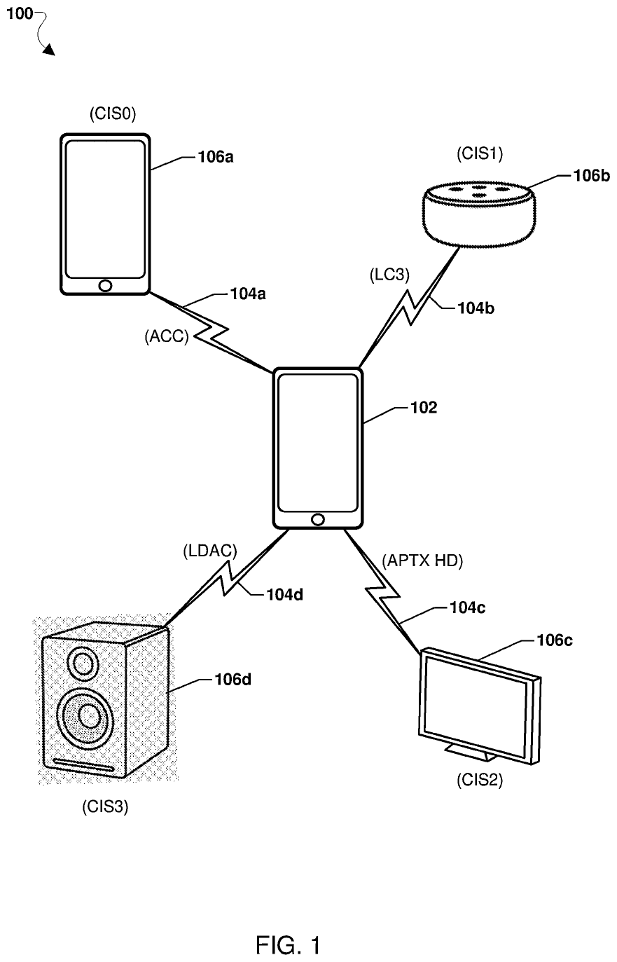

FIG. 1 is a system block diagram illustrating an example communication system suitable for implementing any of the various embodiments. The communication system 100 may be a short-range communications network including multiple devices capable of wireless communication. For example, the communication system 100 may be a BLE communication system including a host device 102 and connected audio output devices 106a-106d. The connected audio output devices 106a-106d may be audio output devices capable of BLE communications and outputting audio signals based on audio data sourced from the host device 102. The connected audio output devices 106a-106d may be communicatively coupled to the host device 102 via wireless connections 104a-104d. For ease of illustration, the communication system 100 includes four connected audio output devices 106a-106d of different types in communication with the host device 102. However, fewer or more connected audio output devices 106 may be implemented within the asymmetric hybrid 3D spatial audio system.

The host device 102 may be any device capable of establishing and maintaining multiple simultaneous BLE communications with the connected audio output devices 106a-106d according to a variety of BLE codecs. A connected audio output device 106 may include any device capable of connecting to the host device 102 via BLE and outputting audio signals derived from audio data received from the host device 102. Connected audio output devices 106 may include user equipment (UEs) and consumer and/or commercial computing devices, such as smartphones, XR, AR, MR devices, personal computers, smart televisions, smart boxes, smart speakers, multimedia displays, smart wearable devices, personal hearing devices, or any other device capable of audio output and BLE communications.

The wireless connections 104a-104d may be BLE connections established via handshaking processes between the host device 102 and each connected audio output device 106a-106d. The host device 102 may query or otherwise determine the preferred codec type of each of the connected audio output devices 106a-106d, and may establish each of the wireless connections 104a-104d respectively according to each codec type. The wireless connections 104a-104d may be established according to a preferred codec implemented by each connected audio output device 106a-106d. For example, the host device 102 may be a smartphone capable of implementing a variety of BLE codecs, such as LDAC, ACC, LC3 and aptX HD, and each connected audio output device 106a-106d may implement different codecs.

As illustrated, the connected audio output device 106a may be a smartphone communicatively coupled to the host device 102 via a wireless connection 104a implementing the Advanced Audio Coding (ACC) audio codec, the connected audio output device 106b may be a smart box communicatively coupled to the host device 102 via a wireless connection 104b implementing the LC3 codec, the connected audio output device 106c may be a multimedia system (e.g., smart television) communicatively coupled to the host device 102 via a wireless connection 104c implementing the aptX HD codec, and the connected audio output device 106d may be a speaker communicatively coupled to the host device 102 via a wireless connection 104d implementing the LDAC codec.

As another example, multiple connected audio output devices 106 may share a same codec type, but one device within the communication system 100 may have a different codec type. The host device 102 may establish the wireless connections 104a-104d accordingly with two connected audio output devices implementing one codec type and the other connected audio output device implemented the different codec type. The host device 102 may support as many wireless connections 104a-104d and as many codec types as possible as defined by the modem and audio codec capabilities of the host device 102.

The host device 102 may transmit audio data to the connected audio output devices 106a-106d according to the specific codec implemented by each wireless connection 104a-104d. For example, the host device 102 may transmit audio data to the connected audio output device 106a using ACC, the host device 102 may transmit audio data to the connected audio output device 106b using LC3, the host device 102 may transmit audio data to the connected audio output device 106c using aptX HD, and the host device 102 may transmit audio data to the connected audio output device 106d using LDAC. The host device 102 may transmit the same audio data or audio data streams to each connected audio output device 106a-106d in offset/aligned intervals to cause the connected audio output devices 106a-106d to output audio signals in a synchronized manner based on the audio data.

In some embodiments, the host device 102 may also function as an audio output device to output audio signals based on the audio data in a synchronized manner with other connected audio output devices 106a-106d. For example, the host device 102 may transmit audio data to the connected audio output devices 106a-106d for synchronous audio output, and may also utilize the same audio data to output audio signals synchronized with the audio output from the connected audio output devices 106a-106d. Thus, the host device 102 may function as an additional audio speaker within an asymmetric hybrid 3D spatial audio system.

The host device 102 may encode audio data to be transmitted to the connected audio output devices 106a-106d via the wireless connections 104a-104d (i.e., across CIS channels). The host device 102 may have a different codec encoding delay corresponding to each wireless connection 104a-104d, in which a codec encoding delay is a total time for the host device 102 to encode audio data according to a codec type of a wireless connection 104.

The host device 102 may determine or otherwise obtain a codec decoding delay that is a time value or duration for a connected audio output device 106 to decode encoded audio data received from the host device 102. A codec decoding delay may be dependent on or otherwise defined by a codec type implemented by a connected audio output device 106. Thus, each wireless connection 104a-104d may have an encoding-decoding delay (i.e., total of the time for the host device 102 to encode audio data plus the time for the connected audio output device 106 to decode the encoded audio data) based on the codec of each wireless connection 104a-104d.

In some embodiments, the host device 102 may receive a decoding delay value from each connected audio output device 106a-106d as part of a response message for initializing the wireless connections 104a-104d respectively. In some embodiments, the host device, after establishing a wireless connection 104, may transmit a request message to a connected audio output device 106 requesting a response message including the decoding delay value. In some embodiments, if a connected audio output device 106 is unaware of its decoding delay or is otherwise unable to provide a decoding delay value to the host device 102, the host device 102 may utilize a default decoding delay value according to the codec type of the connected audio output device 106, thereby determining an estimated encoding-decoding delay that is close to the actual encoding-decoding delay.

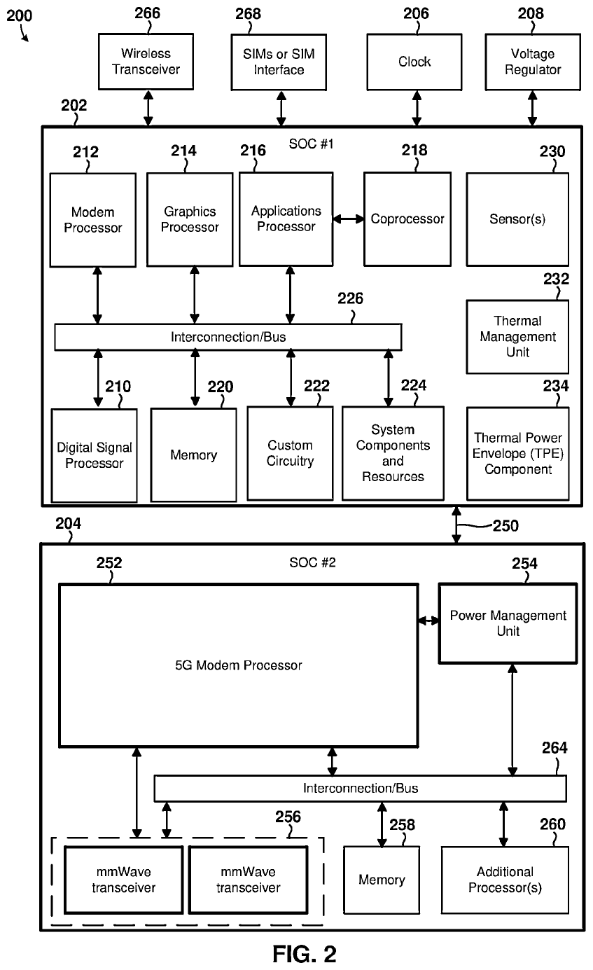

FIG. 2 is a component block diagram illustrating an example computing device 200 suitable for implementing any of the various embodiments. Various embodiments may be implemented on a number of single processor and multiprocessor computer systems, including a system-on-chip (SoC) or system in a package. The computing device 200 may be implemented as a host device (e.g., host device 102). In some embodiments, the computing device 200 may be implemented as a connected audio output device (e.g., connected audio output devices 106a-106d) communicatively coupled to a host device.

With reference to FIGS. 1-2, the illustrated example computing device 200 (which may be a system-in-a-package in some embodiments) includes a two SoCs 202, 204 coupled to a clock 206, a voltage regulator 208, at least one subscriber identity module (SIM) 268 and/or a SIM interface and a wireless transceiver 266 configured to send and receive wireless communications via an antenna (not shown) to/from network computing devices, such as a base station and/or BLE-capable wireless device (e.g., connected audio output devices 106a-106d). In some embodiments, the first SoC 202 operate as central processing unit (CPU) of the computing device that carries out the instructions of software application programs by performing the arithmetic, logical, control and input/output (I/O) operations specified by the instructions. In some embodiments, the second SoC 204 may operate as a specialized processing unit. For example, the second SoC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SoC 202 may include a digital signal processor (DSP) 210, a modem processor 212, a graphics processor 214, an application processor (AP) 216, one or more coprocessors 218 (e.g., vector co-processor) connected to one or more of the processors, memory 220, custom circuitry 222, system components and resources 224, an interconnection/bus module 226, one or more sensors 230 (e.g., accelerometer, temperature sensor, pressure sensor, optical sensor, infrared sensor, analog sound sensor, etc.), a thermal management unit 232, and a thermal power envelope (TPE) component 234. The second SoC 204 may include a 5G modem processor 252, a power management unit 254, an interconnection/bus module 264, the plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SoC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SoC 202, 204 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SoC 202 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 224 and/or custom circuitry 222 may also include circuitry to interface with peripheral devices, such as cameras, electronic displays, wireless communication devices, external memory chips, etc.

The first and second SoC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SoCs 202, 204 may further include an input/output module (not illustrated) for communicating with resources external to the SoC, such as a clock 206, a voltage regulator 208, one or more wireless transceivers 266, and at least one SIM 268 and/or SIM interface (i.e., an interface for receiving one or more SIM cards). Resources external to the SoC (e.g., clock 206, voltage regulator 208) may be shared by two or more of the internal SoC processors/cores. The at least one SIM 268 (or one or more SIM cards coupled to one or more SIM interfaces) may store information supporting multiple subscriptions, including a first 5GNR subscription and a second 5GNR subscription, etc.

In addition to the example computing device 200 discussed above, various embodiments may be implemented in a wide variety of computing systems, which may include a single processor, multiple processors, multicore processors, or any combination thereof.

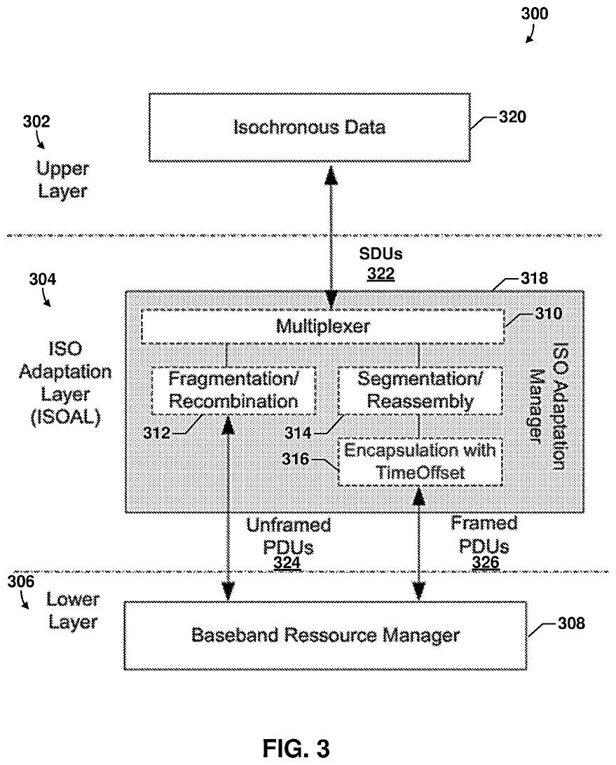

FIG. 3 is a component block diagram illustrating a software architecture 300 including a BLE stack implemented by a host device for establishing and maintaining multiple BLE connections for implementing any of the various embodiments. With reference to FIGS. 1-3, the host device 102 and the connected audio output device 106a-106 may implement the software architecture 300 to facilitate communication between the host device 102 and the connected audio output devices 106a-106d of a communication system (e.g., communication system 100). The software architecture 300 may be implemented by the host device 102 at least for purposes of encoding (fragmenting and recombining) audio data, and by the connected audio output devices 106a-106d at least for purposes of decoding (segmenting and reassembling) encoded audio data received from the host device 102. The software architecture 300 may be distributed among one or more processors (e.g., the processors 212, 214, 216, 218, 252, 260). While illustrated with respect to one BLE stack, in a multi-transceiver computing device, the software architecture 300 may include multiple protocol stacks, each of which may be associated with a different transceiver (e.g., two protocol stacks associated with two transceivers, respectively, in a dual-transceiver wireless communication device). While described below with reference to BLE communication layers, the software architecture 300 may support any variety of standards and protocols for wireless communications, and/or may include additional protocol stacks that support any variety of wireless communications standards and protocols. Various features of the software architecture 300 are described in more detail in Bluetooth Core Specification Version 5.2, Vol. 6, Parts A and G-Isochronous Adaptation Layer.

The software architecture 300 may include an Upper Layer 302, Isochronous Adaptation Layer 304 (illustrated as ISO Adaptation Layer (ISOAL)), and a Lower Layer 306 that may include a baseband resource manager. The Upper Layer 302 may generate and/or receive isochronous data 308 in data packets known as Service Data Units (SDUs) 322. Note that SDUs 322 in the ISOAL 304 have no relation to SDUs in the L2CAP layer. The interface between the Upper Layer 302 and ISOAL 304 may be a Host Controller Interface (HCI) or a proprietary interface (not shown). The ISOAL 304 may provide a mechanism such that the timing used to generate or receive isochronous data 320 in the upper layer 302 can be independent of the timing used in the CIS logical transport used to carry the isochronous data.

The ISOAL 304 may include a multiplexer 310, a fragmentation/recombination module 312, a segmentation/reassembly module 314, and an encapsulation module 316, all within or controlled by an ISO adaptation manager 318. The ISOAL 304 may convert upper layer isochronous data units 320 to lower layer isochronous data packets (and vice versa). The ISOAL 304 may provide segmentation, fragmentation, reassembly, and recombination services for conversion of SDUs 322 from the upper layer to Protocol Data Units (PDUs) 324, 326 of the Baseband Resource Manager 308 and vice versa. The ISOAL 304 may accept or generate SDUs 322, each with a length up to the maximum length (i.e., Max_SDU), at a rate that is supported by the Controller. SDUs 322 may be transferred to and from the upper layer 302 using either HCI ISO Data packets or over an implementation-specific transport.

The fragmentation process may split an SDU into one or more fragments which are carried by one or more unframed PDUs 318 in a CIS of a CIG. A fragment may contain isochronous data. An SDU 322 with a length less than or equal to the Max_PDU may be sent in a single unframed PDU 318. An SDU 322 with a length greater than the Max_PDU may be sent in multiple fragments in multiple unframed PDUs 318. The fragmentation process may use the minimum number of unframed PDUs 318 to transmit an SDU 322. The recombination process may generate an SDU 322 from one or more fragments received in unframed PDUs 324. The segmentation process may split an SDU 322 into one or more segments which are carried by one or more framed PDUs 326 in a CIS of a CIG. A segment may contain a Segmentation Header and may contain Time_Offset and isochronous data. The reassembly process may combine data from one or more segments received in framed PDUs 326 and may generate one or more SDUs. 322

Each CIS may be part of a CIG. A CIG may have one or more CISes. Multiple CISes in a CIG may have a common timing reference based on the master timing and are synchronized in time. The common timing reference of multiple CISes may help devices synchronize their input or output data (i.e., audio data). For example, when the left and right channels of an audio stereo stream, which are received by separate devices, need to be rendered at the same time. multiple CISes in a CIG can be scheduled sequentially or in an interleaved arrangement. Accordingly, multiple CISes can be scheduled across multiple BLE connections (e.g., wireless connections 104a-104d) to output audio data to multiple connected audio output devices (e.g., connected audio output devices 106a-106d) simultaneously.

A CIG may include either two or more CISes that have the same ISO_Interval and are expected to have a time relationship at the application layer, or of a single CIS. A CIG comes into existence when its first CIS is created and ceases to exist when all of its constituent CISes have been terminated. The master's (e.g., host device 102) Host may assign an identifier (e.g., CIS_ID) to each CIG. For example, the host device 102 linked to the connected audio output device 106a via the wireless connection 104a may denote the connected audio output device 106a with an identifier of CIS0, the host device 102 linked to the connected audio output device 106b via the wireless connection 104b may denote the connected audio output device 106b with an identifier of CIS1, the host device 102 linked to the connected audio output device 106c via the wireless connection 104c may denote the connected audio output device 106c with an identifier of CIS2, and the host device 102 linked to the connected audio output device 106d via the wireless connection 104d may denote the connected audio output device 106d with an identifier of CIS3.

The CIS_ID may be sent to the slave's (e.g., connected audio output device 106a-106) Host via the two Link Layers as part of creation of each CIS in the CIG but is not otherwise used by the Link Layer. All CISes in a CIG may have the same master but may have different slaves. All CISes in a CIG may have different CIS_IDs, but if a CIS is terminated or considered lost another may then be created in the same CIG with the same CIS_ID.

Various embodiments may configure the CISes defined by the software architecture 300 to include a present compensation delay in one or more CIS channels within the ISOAL 304. Each wireless connection 104a-104d may be a BLE connection that includes a CIS of a CIG. The host device 102 may configure a CIS or otherwise introduce delay within a CIS channel corresponding to a connected audio output device 106 to ensure that all connected audio output devices 106a-106d having CISes within a same CIG output audio synchronously.

In some embodiments, the host device 102 may configure a CIS to implement a delay ahead of the audio data transmitted by the host device 102 to a connected audio output device 106, such that the connected audio output device 106 may receive and then decode the audio data at a delayed time. For example, the host device 102 may configure a CIS to include a present compensation delay ahead of CIS data packets (i.e., audio data).

In some embodiments, the host device 102 may configure a CIS to implement a delay or delay message or instruction after a connected audio output device 106 receives and decodes the CIS data packets (i.e., audio data), such that the connected audio output device 106 may decode the audio data and wait a time interval equal to the delay or defined by the delay message before outputting audio signals based on the decoded audio data.

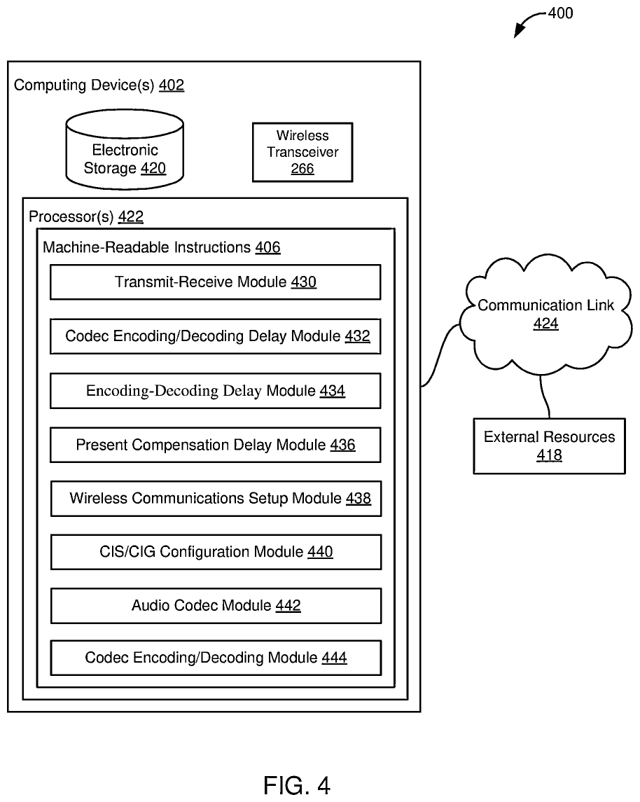

FIG. 4 is a component block diagram illustrating an example system 400 configured to synchronize BLE audio according to some embodiments. With reference to FIGS. 1-4, the system 400 may include one or more computing device(s) 402 (e.g., the host device(s) 102, 200; connected audio output devices 106a-106d) and external resources 418, which may communicate via a wireless communication network 424. External resources 418 may include sources of information outside of the system 400, external entities participating with the system 400, or other resources. In some implementations, some or all of the functionality attributed herein to external resources 418 may be provided by resources included in the system 400. The system 400 may include a plurality of hardware, software, and/or firmware components operating together to provide the functionality attributed herein to the processor 422.

The computing device(s) 402 may include electronic storage 420 that may be configured to store information related to functions implemented by a transmit-receive module 430, a codec encoding/decoding delay module 432, an encoding-decoding delay module 434, a present compensation delay module 436, a wireless communications setup module 438, a CIS/CIG configuration module 440, an audio codec module 442, a codec encoding/decoding module 444, and any other instruction modules.

The electronic storage 420 may include non-transitory storage media that electronically stores information. The electronic storage 420 may include one or both of system storage that is provided integrally (i.e., substantially non-removable) with the system 400 and/or removable storage that is removably connectable to the system 400 via, for example, a port (e.g., a universal serial bus (USB) port, a firewire port, etc.) or a drive (e.g., a disk drive, etc.).

In various embodiments, electronic storage 420 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The electronic storage 420 may include one or more virtual storage resources (e.g., cloud storage, a virtual private network, and/or other virtual storage resources). The electronic storage 420 may store software algorithms, information determined by processor(s) 422, and/or other information that enables the system 400 to function as described herein.

The computing device(s) 402 may be configured by machine-readable instructions 406. Machine-readable instructions 406 may include one or more instruction modules. The instruction modules may include computer program modules. The instruction modules may include one or more of the transmit-receive module 430, the codec encoding/decoding delay module 432, the encoding-decoding delay module 434, the present compensation delay module 436, the wireless communications setup module 438, the CIS/CIG configuration module 440, the audio codec module 442, the codec encoding/decoding module 444, and other instruction modules (not illustrated). The computing device(s) 402 may include processor(s) 422 configured to implement the machine-readable instructions 406 and corresponding modules.

The processor(s) 422 may include one of more local processors that may be configured to provide information processing capabilities in the system 400. As such, the processor(s) 422 may include one or more of a digital processor, an analog processor, a digital circuit designed to process information, an analog circuit designed to process information, a state machine, and/or other mechanisms for electronically processing information. Although the processor(s) 422 is shown in FIG. 4 as a single entity, this is for illustrative purposes only. In some embodiments, the processor(s) 422 may include a plurality of processing units. These processing units may be physically located within the same device, or the processor(s) 422 may represent processing functionality of a plurality of devices distributed in the system 400.

In some embodiments, the processor(s) 422 executing the transmit-receive module 430 may be configured to transmit and receive information with the external resources 418 via the wireless communication network 424. In some embodiments, the processor(s) 422 executing the transmit-receive module 430 may be configured to transmit audio data to the first connected audio output device and the second connected audio output device via the first BLE connection and the second BLE connection. In some embodiments, the processor(s) 422 executing the transmit-receive module 430 may be configured to transmit a first codec decoding delay request message to the first connected audio output device. In some embodiments, the processor(s) 422 executing the transmit-receive module 430 may be configured to receive a first codec decoding delay response message from the first connected audio output device. In some embodiments, the processor(s) 422 executing the transmit-receive module 430 may be configured to transmit a second codec decoding delay request message to the second connected audio output device. In some embodiments, the processor(s) 422 executing the transmit-receive module 430 may be configured to receive a second codec decoding response message from the second connected audio output device.

In some embodiments, the processor(s) 422 executing the codec encoding/decoding delay module 432 may be configured to determine a first codec decoding delay of a first connected audio output device communicatively coupled to the host device via a first BLE connection. In some embodiments, the processor(s) 422 executing the codec encoding/decoding delay module 432 may be configured to determine a second codec decoding delay of a second connected audio output device communicatively coupled to the host device via a second BLE connection. In some embodiments, the processor(s) 422 executing the codec encoding/decoding delay module 432 may be configured to determine whether the first codec decoding delay was received from the first connected audio output device.

In some embodiments, the processor(s) 422 executing the encoding-decoding delay module 434 may be configured to determine a first encoding-decoding delay based on the first codec decoding delay and a first codec encoding delay of the host device for the first BLE connection. In some embodiments, the processor(s) 422 executing the encoding-decoding delay module 434 may be configured to determine a second encoding-decoding delay based on the second codec decoding delay and a second codec encoding delay of the host device for the second BLE connection.

In some embodiments, the processor(s) 422 executing the present compensation delay module 436 may be configured to determine a present compensation delay as a time difference between the first encoding-decoding delay and the second encoding-decoding delay. In some embodiments, the processor(s) 422 executing the present compensation delay module 436 may be configured to configure one of the first BLE connection or the second BLE connection to include the present compensation delay.

In some embodiments, the processor(s) 422 executing the wireless communications setup module 438 may be configured to establish wireless connections between a host device and multiple connected audio output devices.

In some embodiments, the processor(s) 422 executing the CIS/CIG configuration module 440 may be configured to configure one of the first BLE connection or the second BLE connection to include the present compensation delay. In some embodiments, the processor(s) 422 executing the CIS/CIG configuration module 440 may be configured to transmit audio data to the first connected audio output device and the second connected audio output device via the first BLE connection and the second BLE connection. In some embodiments, the processor(s) 422 executing the CIS/CIG configuration module 440 may be configured to configure one of the first BLE connection or the second BLE connection to include the present compensation delay.

In some embodiments, the processor(s) 422 executing the audio codec module 442 may be configured to determine a codec encoding delay and a default codec decoding delay based on a codec type of a connected audio output device.

In some embodiments, the processor(s) 422 executing the codec encoding/decoding module 444 may be configured to encode audio data and decode audio data using a codec.

The processor(s) 422 may execute the modules 430-444 and/or other modules by software, hardware, firmware, some combination of software, hardware, and/or firmware, and/or other mechanisms for configuring processing capabilities on processor(s) 422.

The description of the functionality provided by the different modules 430-444 is for illustrative purposes, and is not intended to be limiting, as any of modules 430-444 may provide more or less functionality than is described. For example, one or more of modules 430-444 may be eliminated, and some or all of its functionality may be provided by other ones of modules 430-444. As another example, processor(s) 422 may execute one or more additional modules that may perform some or all of the functionality attributed below to one of modules 430-444.

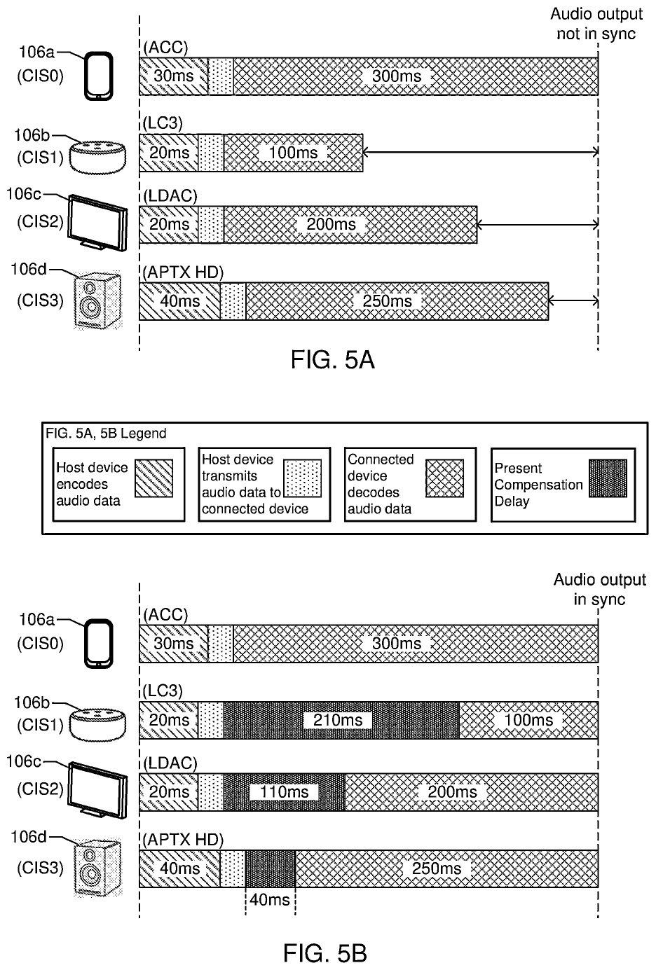

FIG. 5A is a block diagram illustrating an example end-to-end delay of a conventional 3D spatial audio system including devices with different audio codes. FIG. 5B is a block diagram illustrating an example end-to-end delay of an asymmetric hybrid 3D spatial audio system including devices with different audio codes according to some embodiments. With reference to FIGS. 1-5B, FIG. 5A illustrates timing issues created when attempting to implement multiple devices with varying codecs in a single 3D spatial audio system, in which an ISOAL 304 of the host device 102 defines CISes within a same CIG that each correspond to a separate connected audio output device. FIG. 5B illustrates a present compensation delay determined or otherwise calculated by the host device 102 for synchronizing audio outputs of multiple devices with varying codecs in a single 3D spatial audio system, in which an ISOAL of the host device 102 defines CISes within a same CIG that each correspond to a separate connected audio output device.

FIGS. 5A and 5B illustrate a legend including patterned processes corresponding to phases of the timing diagrams, including phase directed towards (i) a host device (e.g., host device 102) encoding audio data, (ii) a host device transmitting audio data to a connected audio output device (e.g., connected audio output devices 106a-160d), (iii), connected audio output device decoding audio data, and (iv) a present compensation delay introduced at the ISOAL level (e.g., added to CIS channel; CIS configured to implement delay). The connected audio output devices 106a-106d are illustrated with corresponding timing diagrams, in which each connected audio output device 106a-106d outputs analog audio signals based on decoded audio data at the end of the phase of “connected audio output device decodes audio data.”

The figures illustrate a situation in which the host device 102 has already enumerated a single CIG including CISes (e.g., CIS0, CIS1, CIS2, CIS3) for each BLE connection (e.g., wireless connections 104a-104d) to each connected audio output device 106a-106d respectively. The figures also illustrate a situation in which the transmit times of encoded audio data from the host device 102 to each connected audio output device 106a-106d are equal. The various codec encoding and decoding delay times are merely illustrative and not representative of any actual delay times that may be standardized by a codec type or proprietary codec implementations. Additionally, four connected audio output devices 106a-106d are illustrated as in communication with the host device 102 and have CISes within a same CIG. However, fewer or more connected audio output devices may be implemented within an asymmetric hybrid 3D spatial audio system (e.g., communication system 100).

Referring to FIG. 5A, the host device 102 is not aware of the codec decoding delay times for each CIS corresponding to each connected audio output device 106a-106d. As such, while the host device 102 may initialize encoding of the audio data simultaneously (i.e., at the start of an ISO interval), the resulting audio output from each connected audio output device implementing different codecs will be unsynchronized. This is due to a variance in codec encoding delay among the various codec types implemented by the connected audio output devices 106a-106d, but also due to the variance in codec decoding delays. For example, the host device 102 may have created the following CISes of a single CIG: (i) CIS0 corresponding to connected audio output device 106a that has a preferred codec of ACC with a codec encoding delay of 30 ms and a codec decoding delay of 300 ms; (ii) CIS1 corresponding to connected audio output device 106b that has a preferred codec of LC3 with a codec encoding delay of 20 ms and a codec decoding delay of 100 ms; (iii) CIS2 corresponding to connected audio output device 106c that has a preferred codec of LDAC with a codec encoding delay of 20 ms and a codec decoding delay of 200 ms; and (iv) CIS3 corresponding to connected audio output device 106d that has a preferred codec of aptX HD with a codec encoding delay of 40 ms and a codec decoding delay of 250 ms.

Because the codec encoding and decoding delay times differ amongst the connected audio output devices 106a-106d, the audio output by each connected audio output device 106a-106d will be offset by the differences in total encoding-decoding delay time. For example, the encoding-decoding delay time of the connected audio output device 106a implementing ACC is 330 ms (30 ms+300 ms), the encoding-decoding delay time of the connected audio output device 106b implementing LC3 is 120 ms (20 ms+100 ms), the encoding-decoding delay time of the connected audio output device 106c implementing LDAC is 220 ms (20 ms+200 ms), and the encoding-decoding delay time of the connected audio output device 106d implementing aptX HD is 290 ms (40 ms+250 ms). Using the encoding-decoding delay time of the connected audio output device 106a as a reference point, the connected audio output device 106b will output the audio signals 210 ms ahead of the connected audio output device 106a, the connected audio output device 106c will output the audio signals 110 ms ahead of the connected audio output device 106a, and the connected audio output device 106d will output the analog signals 40 ms ahead of the connected audio output device 106d.

For this reason, conventional 3D spatial audio systems such as those illustrated in FIG. 5A necessarily utilize audio output devices with the same audio settings, wireless settings, and BLE codec to avoid synchronization issues.

FIG. 5B illustrates a situation in which the host device 102 has already received, obtained, measured, or otherwise determined a codec decoding delay and a codec encoding delay for each connected audio output device 106a-106d according to various embodiments. For example, the host device 102 may receive a codec decoding delay value from each connected audio output device 106a-106d as part of a response message for initializing the wireless connections 104a-104d and enumerating the CIS0-CIS3 respectively. In some embodiments, the host device, after establishing a wireless connection 104, may transmit a request message to a connected audio output device 106 requesting a response message including the codec decoding delay value. In some embodiments, if a connected audio output device 106 is unaware of its codec decoding delay or is otherwise unable to provide a codec decoding delay value to the host device 102, the host device 102 may utilize a default decoding delay value according to the codec type of the connected audio output device 106, thereby determining an estimated encoding-decoding delay that is as close to the actual encoding-decoding delay. The host device 102 may obtain, measure, or otherwise determine each codec encoding delay time based on the codec used to establish each wireless connection 104a-104d. For example, the host device 102 may be query a connected audio output device 106 for a codec type, and may determine (e.g., in a lookup table of standardized codecs) a codec encoding delay corresponding to the codec type preferred by the connected audio output device 106.

After obtaining the codec encoding delay and codec decoding delay corresponding to a codec type for each connected audio output device 106a-106d, the host device 102 may calculate or otherwise determine an encoding-decoding delay across each wireless connection 104a-104d based on the codec encoding delays and the codec decoding delays. Using the aforementioned example as described with reference to FIG. 5A, the host device 102 may calculate or otherwise determine the encoding-decoding delay time of the connected audio output device 106a implementing ACC as 330 ms (30 ms+300 ms), the encoding-decoding delay time of the connected audio output device 106b implementing LC3 as 120 ms (20 ms+100 ms), the encoding-decoding delay time of the connected audio output device 106c implementing LDAC as 220 ms (20 ms+200 ms), and the encoding-decoding delay time of the connected audio output device 106d implementing aptX HD as 290 ms (40 ms+250 ms).

The host device may determine which of the encoding-decoding delays among the connected audio output devices 106a-106 is the largest, and the calibrate the CIS channels of the connected audio output devices 106 with faster encoding-decoding delays to synchronize the audio outputs of all connected audio output devices. For example, the host device 102 may determine that the longest, or maximum, encoding-decoding delay is 330 ms corresponding to CIS0 of connected audio output device 106. The host device 102 may then determine a present compensation delay for each CIS channel that is faster or shorter than the maximum encoding-decoding delay, in which the present compensation delay may be calculated as the difference between the encoding-decoding delay of the CIS and the determined maximum encoding-decoding delay.

In some embodiments, if an encoding-decoding delay of one CIS channel is equal to the maximum encoding-decoding delay, then the present compensation delay for that channel is equal to zero, and no delay is introduced into the CIS and/or the CIS is not reconfigured to implement a delay. For example, the host device 102 may calculate or otherwise determine, a present compensation delay (PCD0) for the connected audio output device 106a as 0 ms (330 ms-330 ms), a present compensation delay (PCD1) for the connected audio output device 106b as 210 ms (330 ms-120 ms), a present compensation delay (PCD2) for the connected audio output device 106c as 110 ms (330 ms-220 ms), and a present compensation delay (PCD3) for the connected audio output device 106d as 40 ms (330 ms-290 ms).

After determining the present compensation delays for each CIS, the host device 102 may insert the present compensation delay into each CIS or otherwise configure each CIS to include the corresponding present compensation delay. For example, no present compensation delay is introduced into CIS0 as the limiting stream with the largest encoding-decoding delay. The host device 102 may configure the CIS1 to include a present compensation delay of 210 ms, may configure the CIS2 to include a present compensation delay of 110 ms, and may configure the CIS3 to include a present compensation delay of 40 ms. Thus, with the addition of the present compensation delays, the connected audio output device 106a-106d CISes may be calibrated to a uniform 330 ms, and the connected audio output devices 106a-106d may output audio signals in a synchronized manner after each device finishes decoded encoded audio data received from the host device 102 across each CIS.

As illustrated, a CIS may be configured to include a present compensation delay that is initiated after the host device 102 transmits the audio data to each connected audio output device 106a-106d, such that each connected audio output device 106 configured to have a present compensation delay begins decoding the encoded audio data after a duration equal to a corresponding present compensation delay time. In some embodiments, the host device 102 may configure CISes to include or insert a present compensation delay between the encoding phase and the transmission phase, such that the host device 102 encodes the audio data according to each codec, waits a duration equal to a corresponding present compensation delay for each CIS, then transmits the encoded audio data to the connected audio output devices 106a-106d.

In some embodiments, a connected audio output device 106 may be unaware of its codec decoding delay or may otherwise be unable to provide a codec decoding delay to the host device 102. The host device 102 may then utilize a default decoding delay value according to the codec type of the connected audio output device 106 (e.g., from a lookup table of standardized codecs), thereby determining an estimated encoding-decoding delay that is equal to or as close to the actual encoding-decoding delay.

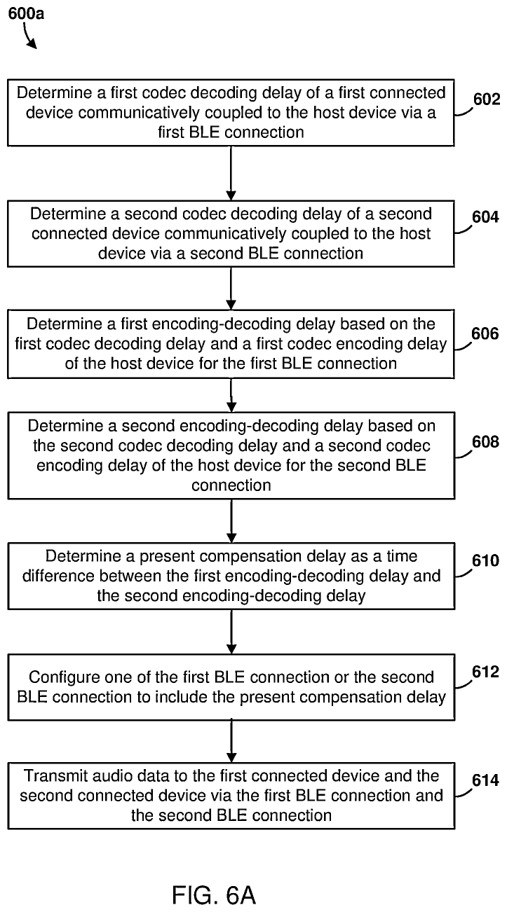

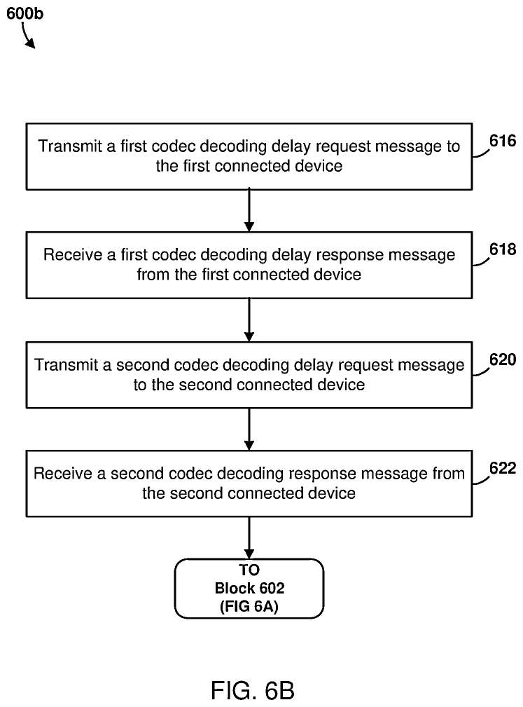

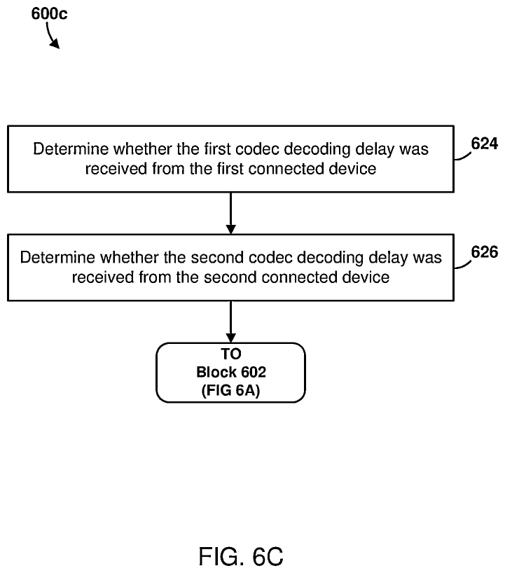

FIG. 6A is a process flow diagram of an example method 600a that may be performed by a processor of a host device for syncing BLE audio in accordance with various embodiments. FIGS. 6B and 6C are process flow diagrams of example operations 600b and 600c that may be performed as part of the method 600a as described for syncing BLE audio in accordance with some embodiments. With reference to FIGS. 1-6C, the method 600a and the operations 600b and 600c may be performed by a processor (e.g., 210, 212, 214, 216, 218, 252, 260, 422) of a host device (e.g., 102, 200, 402). In some embodiments, the processor (e.g., 210, 212, 214, 216, 218, 252, 260, 422) may be configured to perform the operations by processor-executable instructions stored in a non-transitory processor-readable medium (e.g., 220, 258, 420). Means for performing each of the operations of the method 600a and the operations 600b and 600c may be a processor of the systems 100, 200, 400, such as the processors 210, 212, 214, 216, 218, 252, 260, 422, and/or the like as described with reference to FIGS. 1-5B.

In block 602, the processor of the host device (e.g., 102) may perform operations including determining a first codec decoding delay of a first connected audio output device (e.g., 106a-106d) communicatively coupled to the host device via a first BLE connection (e.g., wireless connections 104a-104d). In some embodiments, the host device may determine the first codec decoding delay of the first connected audio output device by analyzing a first connection response message (e.g., wireless connection setup message, handshaking message) received from the first connected audio output device when establishing the first BLE connection. In some embodiments, the first BLE connection may include a first CIS of a CIG. For example, the host device 102 may receive a codec decoding delay value from each connected audio output device 106a-106d as part of a response message for initializing the wireless connections 104a-104d and enumerating the CIS respectively. In some embodiments, the host device, after establishing a wireless connection 104, may transmit a request message to a connected audio output device 106 requesting a response message including the codec decoding delay value. In some embodiments, if a connected audio output device 106 is unaware of its codec decoding delay or is otherwise unable to provide a codec decoding delay value to the host device 102, the host device 102 may utilize a default decoding delay value according to the codec type of the connected audio output device 106, thereby determining an estimated encoding-decoding delay that is as close to the actual encoding-decoding delay. The host device 102 may obtain, measure, or otherwise determine each codec encoding delay time based on the codec used to establish each wireless connection. For example, the host device 102 may be query a connected audio output device 106 for a codec type, and may determine (e.g., in a lookup table of standardized codecs) a codec encoding delay corresponding to the codec type preferred by the connected audio output device 106. Means for performing the operations of block 602 may include a processor (e.g., 210, 212, 214, 216, 218, 252, 260, 422) of a host device (e.g., 102, 200, 402) executing the codec encoding/decoding delay module 432.

In block 604, the processor of the host device (e.g., 102) may perform operations including determining a second codec decoding delay of a second connected audio output device (e.g., 106a-106d) communicatively coupled to the host device via a second BLE connection (e.g., wireless connections 104a-104d). The host device may determine the second codec decoding delay of the second connected audio output device in block 604 using the same operations and alternatives as described in block 602. In some embodiments, the operations in blocks 602 and 604 may be performed in the same operation, such as by obtaining all of the codec decoding delays of all connected audio output devices at the time of establishing communication links with the devices. Means for performing the operations of block 604 may include a processor (e.g., 210, 212, 214, 216, 218, 252, 260, 422) of a host device (e.g., 102, 200, 402) executing the codec encoding/decoding delay module 432.

In block 606, the processor of the host device (e.g., 102) may perform operations including determining a first encoding-decoding delay based on the first codec decoding delay and a first codec encoding delay of the host device for the first BLE connection (e.g., wireless connections 104a-104d). In some embodiments, the first encoding-decoding delay may be a time value equal to the sum of the first codec encoding delay and the first codec decoding delay. Means for performing the operations of block 606 may include a processor (e.g., 210, 212, 214, 216, 218, 252, 260, 422) of a host device (e.g., 102, 200, 402) executing the encoding-decoding delay module 434.

In block 608, the processor of the host device (e.g., 102) may perform operations including determining a second encoding-decoding delay based on the second codec decoding delay and a second codec encoding delay of the host device for the second BLE connection (e.g., wireless connections 104a-104d). In some embodiments, the second encoding-decoding delay may be a time value equal to the sum of the second codec encoding delay and the second codec decoding delay. Means for performing the operations of block 608 may include a processor (e.g., 210, 212, 214, 216, 218, 252, 260, 422) of a host device (e.g., 102, 200, 402) executing the encoding-decoding delay module 434.

In block 610, the processor of the host device (e.g., 102) may perform operations including determining a present compensation delay as a time difference between the first encoding-decoding delay and the second encoding-decoding delay. The present compensation delay may be a time value that may be implemented by a CIS to delay audio transmission, receiving, encoding, and/or decoding processes to synchronize audio output with another CIS channel. Means for performing the operations of block 610 may include a processor (e.g., 210, 212, 214, 216, 218, 252, 260, 422) of a host device (e.g., 102, 200, 402) executing the present compensation delay module 436.

In block 612, the processor of the host device (e.g., 102) may perform operations including configuring one of the first BLE connection or the second BLE connection to include the present compensation delay. In some embodiments, configuring one of the first BLE connection or the second BLE connection to include the present compensation delay may include configuring one of the first BLE connection or the second BLE connection to include the present compensation delay in the ISOAL of the host device. For example, the host device may configure a CIS with a faster encoding-decoding delay, as compared to a CIS with a slower encoding-decoding delay, to implement the present compensation delay such that the audio outputs of the CISes are aligned. Means for performing the operations of block 612 may include a processor (e.g., 210, 212, 214, 216, 218, 252, 260, 422) of a host device (e.g., 102, 200, 402) executing the present compensation delay module 436 and the CIS/CIG configuration module 440.

In block 614, the processor of the host device (e.g., 102) may perform operations including transmitting audio data to the first connected audio output device and the second connected audio output device via the first BLE connection and the second BLE connection, with each BLE connection including its assigned compensation delay. As a result of configuring one of the first BLE connection or the second BLE connection with the present compensation delay, the first connected audio output device and the second connected audio output device may output audio signals based on the audio data in a synchronized manner. Means for performing the operations of block 614 may include a processor (e.g., 210, 212, 214, 216, 218, 252, 260, 422) of a host device (e.g., 102, 200, 402) executing the present compensation delay module 436 and the transmit/receive module 430 and the CIS/CIG configuration module.

FIG. 6B illustrates operations 600b that may be performed as part of the method 600a for syncing BLE audio in accordance with some embodiments. With reference to FIGS. 1-6B, the processor of the host device (e.g., 102, 200, 402) may perform operations including transmitting a first codec decoding delay request message to the first connected audio output device in block 616. Means for performing the operations of block 616 may include a processor (e.g., 210, 212, 214, 216, 218, 252, 260, 422) of a host device (e.g., 102, 200, 402) executing the transmit/receive module 430.

In block 618, the processor of the host device (e.g., 102) may perform operations including receiving a first codec decoding delay response message from the first connected audio output device (e.g., 106a-106d). In some embodiments, the host device may determine the first codec decoding delay of the first connected audio output device by analyzing the first codec decoding delay response message. Means for performing the operations of block 618 may include a processor (e.g., 210, 212, 214, 216, 218, 252, 260, 422) of a host device (e.g., 102, 200, 402) executing the transmit/receive module 430.

In block 620, the processor of the host device (e.g., 102, 200, 402) may perform operations including transmitting a second codec decoding delay request message to the second connected audio output device. Means for performing the operations of block 620 may include a processor (e.g., 210, 212, 214, 216, 218, 252, 260, 422) of a host device (e.g., 102, 200, 402) executing the transmit/receive module 430.

In block 622, the processor of the host device (e.g., 102) may perform operations including receiving a second codec decoding delay response message from the second connected audio output device (e.g., 106a-106d). In some embodiments, the host device may determine the second codec decoding delay of the second connected audio output device by analyzing the second codec decoding delay response message. Means for performing the operations of block 622 may include a processor (e.g., 210, 212, 214, 216, 218, 252, 260, 422) of a host device (e.g., 102, 200, 402) executing the present the transmit/receive module 430.

After the operations in block 622, the processor may perform the operations in block 602 of the method 600a as described.

FIG. 6C illustrates operations 600c that may be performed as part of the method 600a for syncing BLE audio in accordance with some embodiments. With reference to FIGS. 1-6C, the processor of the host device (e.g., 102, 200, 402) may perform operations including determining whether the first codec decoding delay was received from the first connected audio output device in block 624. In some embodiments, determining the first codec decoding delay of the first connected audio output device may include determining a first default codec decoding delay based on a first codec type of the first BLE connection in response to determining that the first codec decoding delay was not received from the first connected audio output device. In some embodiments, the processor of the host device may determine the default codec decoding delay for each connected audio output device by using a make, model or other identifier of each device to look up a corresponding device-specific codec decoding delay in a data table stored in memory of the host device. In some embodiments, a host device may be provided with such a data table of device-specific codec decoding delays during manufacture, via over-the-air updates, via downloading tables from a remote server, or as part of a product connection process, with the data table stored in non-volatile memory. In some embodiments, a host device may access an external database, such as a remote server via a network (e.g., the Internet) and download an appropriate default device-specific codec decoding delay, such as by sending a make, model or other device information to the remote server and receiving the default information in response. Other methods of determining an appropriate default device-specific codec decoding delay may be implemented in block 624. Means for performing the operations of block 624 may include a processor (e.g., 210, 212, 214, 216, 218, 252, 260, 422) of a host device (e.g., 102, 200, 402) executing the codec encoding/decoding delay module 432 and the audio codec module 442.

In block 626, the processor of the host device (e.g., 102) may perform operations including determining whether the second codec decoding delay was received from the second connected audio output device. In some embodiments, determining the second codec decoding delay of the second connected audio output device may include determining a second default codec decoding delay based on a second codec type of the second BLE connection in response to determining that the second codec decoding delay was not received from the second connected audio output device. The processor of the host device may use the same alternative methods for determining an appropriate default device-specific codec decoding delay for the second connected audio output device as for the first connected audio output device described in block 624. Means for performing the operations of block 626 may include a processor (e.g., 210, 212, 214, 216, 218, 252, 260, 422) of a host device (e.g., 102, 200, 402) executing the codec encoding/decoding delay module 432 and the audio codec module 442.

After the operations in block 622, the processor may perform the operations in block 602 of the method 600 as described.

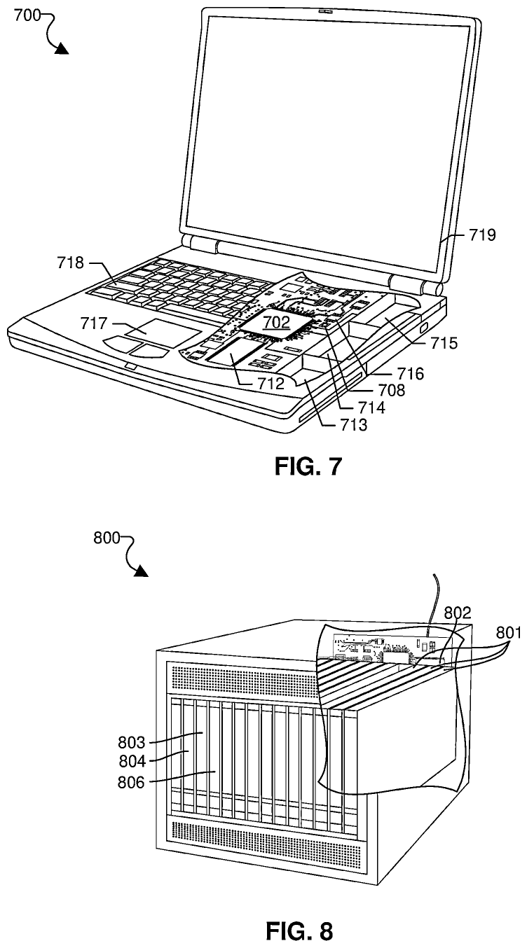

The various embodiments (including, but not limited to, embodiments described above with reference to FIGS. 1-6C) may be implemented in a wide variety of computing systems include a laptop computer 700 an example of which is illustrated in FIG. 7. With reference to FIGS. 1-7, a laptop computer may include a touchpad touch surface 717 that serves as the computer's pointing device, and thus may receive drag, scroll, and flick gestures similar to those implemented on computing devices equipped with a touch screen display and described above. A laptop computer 700 will typically include a processor 702 coupled to volatile memory 712 and a large capacity nonvolatile memory, such as a disk drive 713 of Flash memory. Additionally, the computer 700 may have one or more antenna 708 for sending and receiving electromagnetic radiation that may be connected to a wireless data link and/or cellular telephone transceiver 716 coupled to the processor 702. The computer 700 may also include a floppy disc drive 714 and a compact disc (CD) drive 715 coupled to the processor 702. The laptop computer 700 may include a touchpad 717, a keyboard 718, and a display 719 all coupled to the processor 702. Other configurations of the computing device may include a computer mouse or trackball coupled to the processor (e.g., via a USB input) as are well known, which may also be used in conjunction with the various embodiments.

FIG. 8 is a component block diagram of a network computing device 800, suitable for use with various embodiments. Such network computing devices may include at least the components illustrated in FIG. 8. With reference to FIGS. 1-8, the network computing device 800 may include a processor 801 coupled to volatile memory 802 and a large capacity nonvolatile memory, such as a disk drive 803.

The network computing device 800 may also include a peripheral memory access device such as a floppy disc drive, compact disc (CD) or digital video disc (DVD) drive 806 coupled to the processor 801. The network computing device 800 may also include network access ports 804 (or interfaces) coupled to the processor 801 for establishing data connections with a network, such as the Internet and/or a local area network coupled to other system computers and servers.

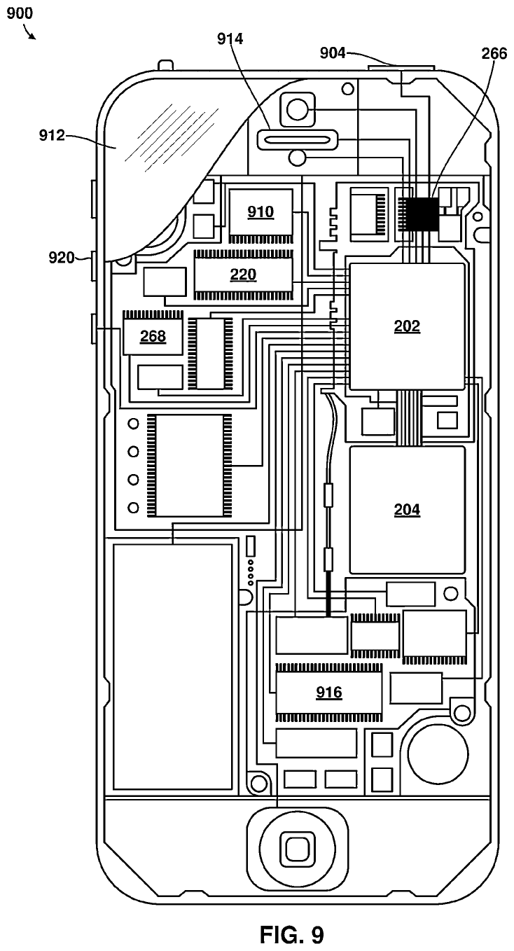

FIG. 9 is a component block diagram of a computing device 900 suitable for use with various embodiments. With reference to FIGS. 1-9, various embodiments may be implemented on a variety of computing devices 900 (e.g., computing device 102, 320, 402), an example of which is illustrated in FIG. 9 in the form of a smartphone. The computing device 900 may include a first SoC 202 (e.g., a SoC-CPU) coupled to a second SoC 204 (e.g., a 5G capable SoC). The first and second SoCs 202, 204 may be coupled to internal memory 916, a display 912, and to a speaker 914. The first and second SoCs 202, 204 may also be coupled to at least one SIM 268 and/or a SIM interface that may store information supporting a first 5GNR subscription and a second 5GNR subscription, which support service on a 5G non-standalone (NSA) network.

The computing device 900 may include an antenna 904 for sending and receiving electromagnetic radiation that may be connected to a wireless transceiver 266 coupled to one or more processors in the first and/or second SoCs 202, 204. The computing device 900 may also include menu selection buttons or rocker switches 920 for receiving user inputs.

The computing device 900 also includes a sound encoding/decoding (CODEC) circuit 910, which digitizes sound received from a microphone into data packets suitable for wireless transmission and decodes received sound data packets to generate analog signals that are provided to the speaker to generate sound. Also, one or more of the processors in the first and second SoCs 202, 204, wireless transceiver 266 and CODEC 910 may include a digital signal processor (DSP) circuit (not shown separately).

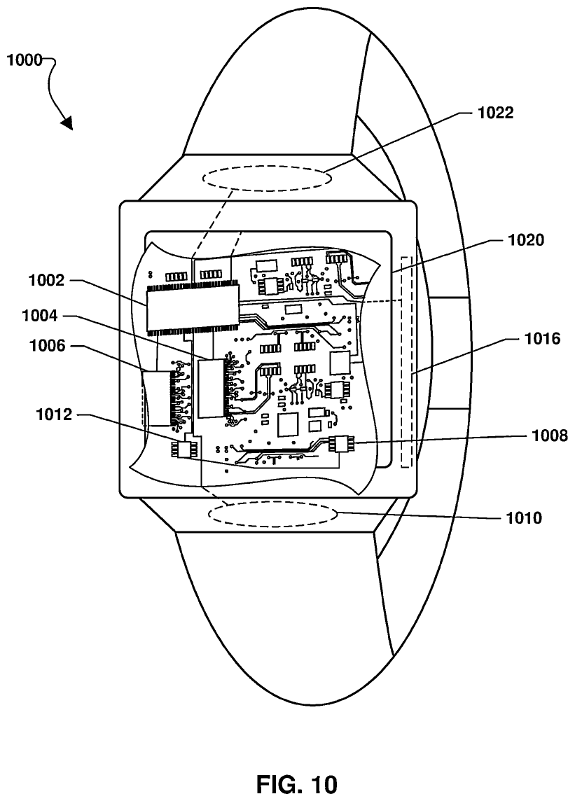

The various embodiments may be implemented within a variety of computing devices, such as a wearable computing device. FIG. 10 illustrates an example wearable computing device in the form of a smart watch 1000 according to some embodiments. A smart watch 1000 may include a processor 1002 coupled to internal memories 1004 and 1006. Internal memories 1004, 1006 may be volatile or non-volatile memories, and may also be secure and/or encrypted memories, or unsecure and/or unencrypted memories, or any combination thereof. The processor 1002 may also be coupled to a touchscreen display 1020, such as a resistive-sensing touchscreen, capacitive-sensing touchscreen infrared sensing touchscreen, or the like. Additionally, the smart watch 1000 may have one or more antenna 1008 for sending and receiving electromagnetic radiation that may be connected to one or more wireless data links 1012, such as one or more Bluetooth®; transceivers, Peanut transceivers, Wi-Fi transceivers, ANT+ transceivers, etc., which may be coupled to the processor 1002. The smart watch 1000 may also include physical virtual buttons 1022 and 1010 for receiving user inputs as well as a slide sensor 1016 for receiving user inputs.

The touchscreen display 1020 may be coupled to a touchscreen interface module that is configured receive signals from the touchscreen display 1020 indicative of locations on the screen where a user's fingertip or a stylus is touching the surface and output to the processor 1002 information regarding the coordinates of touch events. Further, the processor 1002 may be configured with processor-executable instructions to correlate images presented on the touchscreen display 1020 with the location of touch events received from the touchscreen interface module in order to detect when a user has interacted with a graphical interface icon, such as a virtual button.

The processor 1002 may be any programmable microprocessor, microcomputer or multiple processor chip or chips that can be configured by software instructions (applications) to perform a variety of functions, including the functions of the various embodiments. In some devices, multiple processors may be provided, such as one processor dedicated to wireless communication functions and one processor dedicated to running other applications. Typically, software applications may be stored in an internal memory before they are accessed and loaded into the processor 1002. The processor 1002 may include internal memory sufficient to store the application software instructions. In many devices the internal memory may be a volatile or nonvolatile memory, such as flash memory, or a mixture of both. For the purposes of this description, a general reference to memory refers to memory accessible by the processor 1002 including internal memory or removable memory plugged into the mobile device and memory within the processor 1002 itself.

The processors of the computer 700, the network computing device 800, the computing device 900, and the smart watch 1000 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SoC 204 dedicated to wireless communication functions and one processor within an SoC 202 dedicated to running other applications. Software applications may be stored in the memory 220, 916 before they are accessed and loaded into the processor. The processors may include internal memory sufficient to store the application software instructions.

Example 1. A method performed by a processor of a host device for syncing Bluetooth Low Energy (BLE) audio, including: determining a first codec decoding delay of a first connected audio output device communicatively coupled to the host device via a first BLE connection; determining a second codec decoding delay of a second connected audio output device communicatively coupled to the host device via a second BLE connection; determining a first encoding-decoding delay based on the first codec decoding delay and a first codec encoding delay of the host device for the first BLE connection; determining a second encoding-decoding delay based on the second codec decoding delay and a second codec encoding delay of the host device for the second BLE connection; determining a present compensation delay as a time difference between the first encoding-decoding delay and the second encoding-decoding delay; configuring one of the first BLE connection or the second BLE connection to include the present compensation delay; and transmitting audio data to the first connected audio output device and the second connected audio output device via the first BLE connection and the second BLE connection.

Example 2. The method of example 1, in which the first BLE connection includes a first Connected Isochronous Stream (CIS) of a Connected Isochronous Group (CIG) and the second BLE connection includes a second CIS of the CIG.

Example 3. The method of either of example 1 or 2, in which configuring one of the first BLE connection or the second BLE connection to include the present compensation delay includes configuring one of the first BLE connection or the second BLE connection to include the present compensation delay in the Isochronous Adaptation Layer (ISOAL) of the host device.

Example 4. The method of any of examples 1-3, in which the first BLE connection implements a first codec type and the second BLE connection implements a second codec type that is different from the first codec type.

Example 5. The method of any of examples 1-4, in which: determining the first codec decoding delay of the first connected audio output device includes analyzing a first connection response message received from the first connected audio output device when establishing the first BLE connection; and determining the second codec decoding delay of the second connected audio output device includes analyzing a second connection response message received from the second connected audio output device when establishing the second BLE connection.

Example 6. The method of any of examples 1-5, further including: transmitting a first codec decoding delay request message to the first connected audio output device: receiving a first codec decoding delay response message from the first connected audio output device; transmitting a second codec decoding delay request message to the second connected audio output device; and receiving a second codec decoding delay response message from the second connected audio output device, in which: determining the first codec decoding delay of the first connected audio output device includes analyzing the first codec decoding delay response message, and determining the second codec decoding delay of the second connected audio output device includes analyzing the second codec decoding delay response message.

Example 7. The method of any of examples 1-5, further including: determining whether the first codec decoding delay was received from the first connected audio output device; and determining whether the second codec decoding delay was received from the second connected audio output device, in which: determining the first codec decoding delay of the first connected audio output device includes determining a first default codec decoding delay based on a first codec type of the first BLE connection in response to determining that the first codec decoding delay was not received from the first connected audio output device; and determining the second codec decoding delay of the second connected audio output device includes determining a second default codec decoding delay based on a second codec type of the second BLE connection in response to determining that the second codec decoding delay was not received from the second connected audio output device.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), Long Term Evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general Packet Radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations: these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a Bluetooth Low Energy (BLE) transceiver; and
a processor coupled to the BLE transceiver and configured to:
determine a first codec decoding delay of a first connected audio output device communicatively coupled to the computing device via a first BLE connection;
determine a second codec decoding delay of a second connected audio output device communicatively coupled to the computing device via a second BLE connection;
determine a first encoding-decoding delay based on the first codec decoding delay and a first codec encoding delay of the computing device for the first BLE connection;
determine a second encoding-decoding delay based on the second codec decoding delay and a second codec encoding delay of the computing device for the second BLE connection;
determine a present compensation delay as a time difference between the first encoding-decoding delay and the second encoding-decoding delay;
configuring one of the first BLE connection or the second BLE connection to include the present compensation delay; and
transmitting audio data to the first connected audio output device and the second connected audio output device via the first BLE connection and the second BLE connection.

2. The computing device of claim 1, wherein the first BLE connection includes a first Connected Isochronous Stream (CIS) of a Connected Isochronous Group (CIG) and the second BLE connection includes a second CIS of the CIG.

3. The computing device of claim 1, wherein the processor is further configured to configure one of the first BLE connection or the second BLE connection to include the present compensation delay by configuring one of the first BLE connection or the second BLE connection to include the present compensation delay in the Isochronous Adaptation Layer (ISOAL) of the computing device.

4. The computing device of claim 1, wherein the first BLE connection implements a first codec type and the second BLE connection implements a second codec type that is different from the first codec type.

5. The computing device of claim 1, wherein the processor is further configured to:
determine the first codec decoding delay of the first connected audio output device by analyzing a first connection response message received from the first connected audio output device when establishing the first BLE connection; and
determine the second codec decoding delay of the second connected audio output device by analyzing a second connection response message received from the second connected audio output device when establishing the second BLE connection.

6. The computing device of claim 1, the processor is further configured to:
transmit a first codec decoding delay request message to the first connected audio output device;
receive a first codec decoding delay response message from the first connected audio output device;
transmit a second codec decoding delay request message to the second connected audio output device;
receive a second codec decoding delay response message from the second connected audio output device,
determine the first codec decoding delay of the first connected audio output device by analyzing the first codec decoding delay response message, and
determine the second codec decoding delay of the second connected audio output device by analyzing the second codec decoding delay response message.

7. The computing device of claim 1, the processor is further configured to:
determine whether the first codec decoding delay was received from the first connected audio output device;
determine whether the second codec decoding delay was received from the second connected audio output device,
determine the first codec decoding delay of the first connected audio output device by determining the first default codec decoding delay based on a first codec type of the first BLE connection in response to determining that the first codec decoding delay was not received from the first connected audio output device; and
determine the second codec decoding delay of the second connected audio output device by determining the second default codec decoding delay based on a second codec type of the second BLE connection in response to determining that the second codec decoding delay was not received from the second connected audio output device.

8. A method performed by a processor of a host device for syncing Bluetooth Low Energy (BLE) audio, comprising:
determining a first codec decoding delay of a first connected audio output device communicatively coupled to the host device via a first BLE connection;
determining a second codec decoding delay of a second connected audio output device communicatively coupled to the host device via a second BLE connection;
determining a first encoding-decoding delay based on the first codec decoding delay and a first codec encoding delay of the host device for the first BLE connection;
determining a second encoding-decoding delay based on the second codec decoding delay and a second codec encoding delay of the host device for the second BLE connection;
determining a present compensation delay as a time difference between the first encoding-decoding delay and the second encoding-decoding delay;
configuring one of the first BLE connection or the second BLE connection to include the present compensation delay; and
transmitting audio data to the first connected audio output device and the second connected audio output device via the first BLE connection and the second BLE connection.

9. The method of claim 8, wherein the first BLE connection includes a first Connected Isochronous Stream (CIS) of a Connected Isochronous Group (CIG) and the second BLE connection includes a second CIS of the CIG.

10. The method of claim 8, wherein configuring one of the first BLE connection or the second BLE connection to include the present compensation delay comprises configuring one of the first BLE connection or the second BLE connection to include the present compensation delay in the Isochronous Adaptation Layer (ISOAL) of the host device.

11. The method of claim 8, wherein the first BLE connection implements a first codec type and the second BLE connection implements a second codec type that is different from the first codec type.

12. The method of claim 8, wherein:
determining the first codec decoding delay of the first connected audio output device comprises analyzing a first connection response message received from the first connected audio output device when establishing the first BLE connection; and
determining the second codec decoding delay of the second connected audio output device comprises analyzing a second connection response message received from the second connected audio output device when establishing the second BLE connection.

13. The method of claim 8, further comprising:
transmitting a first codec decoding delay request message to the first connected audio output device;
receiving a first codec decoding delay response message from the first connected audio output device;
transmitting a second codec decoding delay request message to the second connected audio output device; and
receiving a second codec decoding delay response message from the second connected audio output device,
wherein:
determining the first codec decoding delay of the first connected audio output device comprises analyzing the first codec decoding delay response message, and
determining the second codec decoding delay of the second connected audio output device comprises analyzing the second codec decoding delay response message.

14. The method of claim 8, further comprising:
determining whether the first codec decoding delay was received from the first connected audio output device; and
determining whether the second codec decoding delay was received from the second connected audio output device,
wherein:
determining the first codec decoding delay of the first connected audio output device comprises determining the first default codec decoding delay based on a first codec type of the first BLE connection in response to determining that the first codec decoding delay was not received from the first connected audio output device; and
determining the second codec decoding delay of the second connected audio output device comprises determining the second default codec decoding delay based on the second codec type of the second BLE connection in response to determining that the second codec decoding delay was not received from the second connected audio output device.

15. A computing device, comprising:
means for determining a first codec decoding delay of a first connected audio output device communicatively coupled to the computing device via a first Bluetooth Low Energy (BLE) connection;
means for determining a second codec decoding delay of a second connected audio output device communicatively coupled to the computing device via a second BLE connection;
means for determining a first encoding-decoding delay based on the first codec decoding delay and a first codec encoding delay of the computing device for the first BLE connection;
means for determining a second encoding-decoding delay based on the second codec decoding delay and a second codec encoding delay of the computing device for the second BLE connection;
means for determining a present compensation delay as a time difference between the first encoding-decoding delay and the second encoding-decoding delay;
means for configuring one of the first BLE connection or the second BLE connection to include the present compensation delay; and
means for transmitting audio data to the first connected audio output device and the second connected audio output device via the first BLE connection and the second BLE connection.

16. The computing device of claim 15, wherein the first BLE connection includes a first Connected Isochronous Stream (CIS) of a Connected Isochronous Group (CIG) and the second BLE connection includes a second CIS of the CIG.

17. The computing device of claim 15, wherein means for configuring one of the first BLE connection or the second BLE connection to include the present compensation delay comprises means for configuring one of the first BLE connection or the second BLE connection to include the present compensation delay in the Isochronous Adaptation Layer (ISOAL) of the computing device.

18. The computing device of claim 15, wherein the first BLE connection implements a first codec type and the second BLE connection implements a second codec type that is different from the first codec type.

19. The computing device of claim 15, wherein:
means for determining the first codec decoding delay of the first connected audio output device comprises means for analyzing a first connection response message received from the first connected audio output device when establishing the first BLE connection; and
means for determining the second codec decoding delay of the second connected audio output device comprises means for analyzing a second connection response message received from the second connected audio output device when establishing the second BLE connection.

20. The computing device of claim 15, further comprising:
means for transmitting a first codec decoding delay request message to the first connected audio output device;
means for receiving a first codec decoding delay response message from the first connected audio output device;
means for transmitting a second codec decoding delay request message to the second connected audio output device; and
means for receiving a second codec decoding delay response message from the second connected audio output device,
wherein:
means for determining the first codec decoding delay of the first connected audio output device comprises means for analyzing the first codec decoding delay response message, and
means for determining the second codec decoding delay of the second connected audio output device comprises means for analyzing the second codec decoding delay response message.

21. The computing device of claim 15, further comprising:
means for determining whether the first codec decoding delay was received from the first connected audio output device; and
means for determining whether the second codec decoding delay was received from the second connected audio output device,
wherein:
means for determining the first codec decoding delay of the first connected audio output device comprises means for determining the first default codec decoding delay based on a first codec type of the first BLE connection in response to determining that the first codec decoding delay was not received from the first connected audio output device; and
means for determining the second codec decoding delay of the second connected audio output device comprises means for determining the second default codec decoding delay based on a second codec type of the second BLE connection in response to determining that the second codec decoding delay was not received from the second connected audio output device.

22. A non-transitory processor-executable medium having stored thereon processor-executable instructions configured to cause a processor of a computing device to perform operations comprising:
determining a first codec decoding delay of a first connected audio output device communicatively coupled to the computing device via a first syncing Bluetooth Low Energy (BLE) connection;
determining a second codec decoding delay of a second connected audio output device communicatively coupled to the computing device via a second BLE connection;
determining a first encoding-decoding delay based on the first codec decoding delay and a first codec encoding delay of the computing device for the first BLE connection;
determining a second encoding-decoding delay based on the second codec decoding delay and a second codec encoding delay of the computing device for the second BLE connection;
determining a present compensation delay as a time difference between the first encoding-decoding delay and the second encoding-decoding delay;
configuring one of the first BLE connection or the second BLE connection to include the present compensation delay; and
transmitting audio data to the first connected audio output device and the second connected audio output device via the first BLE connection and the second BLE connection.

23. The non-transitory processor-executable medium of claim 22, wherein the first BLE connection includes a first Connected Isochronous Stream (CIS) of a Connected Isochronous Group (CIG) and the second BLE connection includes a second CIS of the CIG.

24. The non-transitory processor-executable medium of claim 22, wherein the stored processor-executable instructions are further configured to cause a processor of a computing device to perform operations such that configuring one of the first BLE connection or the second BLE connection to include the present compensation delay comprises configuring one of the first BLE connection or the second BLE connection to include the present compensation delay in the Isochronous Adaptation Layer (ISOAL) of the computing device.

25. The non-transitory processor-executable medium of claim 22, wherein the stored processor-executable instructions are further configured to cause a processor of a computing device to perform operations such that the first BLE connection implements a first codec type and the second BLE connection implements a second codec type that is different from the first codec type.

26. The non-transitory processor-executable medium of claim 22, wherein the stored processor-executable instructions are further configured to cause a processor of a computing device to perform operations such that:
determining the first codec decoding delay of the first connected audio output device comprises analyzing a first connection response message received from the first connected audio output device when establishing the first BLE connection; and
determining the second codec decoding delay of the second connected audio output device comprises analyzing a second connection response message received from the second connected audio output device when establishing the second BLE connection.

27. The non-transitory processor-executable medium of claim 22, wherein the stored processor-executable instructions are further configured to cause a processor of a computing device to perform operations further comprising:
transmitting a first codec decoding delay request message to the first connected audio output device;
receiving a first codec decoding delay response message from the first connected audio output device;
transmitting a second codec decoding delay request message to the second connected audio output device; and
receiving a second codec decoding delay response message from the second connected audio output device,
wherein the stored processor-executable instructions are further configured to cause a processor of a computing device to perform operations such that:
determining the first codec decoding delay of the first connected audio output device comprises analyzing the first codec decoding delay response message, and
determining the second codec decoding delay of the second connected audio output device comprises analyzing the second codec decoding delay response message.

28. The non-transitory processor-executable medium of claim 22, wherein the stored processor-executable instructions are further configured to cause a processor of a computing device to perform operations further comprising:
determining whether the first codec decoding delay was received from the first connected audio output device; and
determining whether the second codec decoding delay was received from the second connected audio output device,
wherein the stored processor-executable instructions are further configured to cause a processor of a computing device to perform operations such that:
determining the first codec decoding delay of the first connected audio output device comprises determining the first default codec decoding delay based on a first codec type of the first BLE connection in response to determining that the first codec decoding delay was not received from the first connected audio output device; and
determining the second codec decoding delay of the second connected audio output device comprises determining the second default codec decoding delay based on a second codec type of the second BLE connection in response to determining that the second codec decoding delay was not received from the second connected audio output device.
